(19) United States
(12) Patent Application Publication
(10) Pub. No.: US 2003/0181227 A1
(43) Pub. Date: Sep. 25, 2003

(54) Electronic device and antenna mounting method

(75) Inventor: Hirota Toshiyuki, Tokyo (JP)

Correspondence Address: FOLEY & LARDNER, 2029 CENTURY PARK EAST, SUITE 3500, LOS ANGELES, CA, 90067

(73) Assignee: KABUSHIKI KAISHA TOSHIBA

(21) Appl. No.: 10/324,689

(22) Filed: Dec. 20, 2002

(30) Foreign Application Priority Data
Feb. 28, 2002 (JP) JP2002-052774

(51) Int. Cl. H04B 1/034; H04M 1/00; H04B 1/38

(52) U.S. Cl. 455/575.1; 455/551; 455/97

(57) ABSTRACT

In an electronic device having a wireless communication module and an antenna, the antenna is designed such that at least a portion of the antenna is formed from a conductive tape and is shaped to have dimensions such that when the antenna is mounted in contact with a mounting surface on the electronic device, a frequency characteristic of the antenna has a value determined in consideration of a predetermined dielectric constant of the mounting surface. Mounting location indicators are included on the mounting surface, whereby during assembly the antenna can be mounted accurately. The antenna is formed from the conductive tape in a substantially planar shape such that the antenna can be mounted effectively in accordance with the mounting location indicators on the mounting surface within the limited space inside the electronic device.

### RELATED APPLICATIONS

This application is based upon and claims the benefit of priority from the prior Japanese Patent Application No. 2002-052774, filed Feb. 28, 2002, the entire contents of which are incorporated herein by reference.

### BACKGROUND OF THE INVENTION

1. Field of the Invention

The present invention relates to an electronic device capable of performing wireless communication and to an antenna mounting method for the electronic device.

2. Description of the Related Art

Recently, wireless LANs have been taking the place of traditional wired LANs in network environments such as offices and homes. In addition, the number of other devices capable of transmitting and receiving data by wireless communication have been increasing, replacing devices communicating using traditional wires.

For example, a notebook personal computer (hereinafter referred to as a personal computer or PC) incorporates a wireless communication module for performing signal modulation/demodulation processing for wireless communication. Data to be transmitted undergoes predetermined modulation processing, and then radio waves are transmitted through an antenna on the PC operating as a wireless communication interface, whereby data is transmitted. Furthermore, when receiving data, radio waves are received through an antenna on the PC, predetermined demodulation processing is performed in the wireless communication module, and then the received data is passed to a CPU, a memory or the like.

One method for mounting the above-mentioned antenna on the PC is to include a mounting structure on the PC housing and to mount the antenna thereto. Another method is to attach the antenna to the PC housing with, for example, double-sided tape or the like. Yet another method is to cover the antenna with plastic or the like and fasten the plastic to the PC housing, for example with screws or clamps.

However, when the antenna is mounted on the PC housing, the frequency characteristics of the antenna may vary, i.e., the frequency characteristics of the un-mounted antenna may be different from the frequency characteristics of the antenna when mounted to the PC housing. This change in the frequency characteristics of the antenna may occur, for example, as a result of locating the antenna next to other PC components which interfere with the antenna. In addition, when the antenna is mounted in contact with the PC housing, the dielectric constant of the PC housing may change the frequency characteristics of the antenna.

Thus, the performance of the mounted antenna must be taken into account when considering where and how to mount the antenna on the PC housing. However, because manufactures of wireless devices such as PCs generally purchase antennas having particular frequency characteristics from antenna manufacturers, it becomes difficult to match the frequency characteristics of a particular antenna with the dielectric constant of the housing of the PC or other wireless device to which the antenna is mounted.

One method to overcome the dielectric constant problem described above is to include a spacer disposed in the PC housing. The antenna is mounted on the spacer. In this manner, a predetermined space is provided between the antenna and the PC housing.

A device wherein such antenna mounting is employed is described in Jpn. Pat. Appln. KOKAI Publication No. 9-321529, which discloses a method of providing a non-metallic spacer for frequency adjustment between an antenna ground (GND) and a reverse F-shaped antenna.

However, as discussed above, the performance of the mounted antenna must be considered, requiring increased effort in design. Furthermore, it may be difficult to secure space in the notebook PC for disposing a mounting part such as the spacer, due to size and weight considerations.

Moreover, when the antenna is mounted such that it is spaced from the housing with the spacer, variations in the placement of the antenna on the device during the assembly process may cause some variations in the frequency characteristics of the mounted antenna. Therefore, fabrication specifications for the antenna must be highly accurate and/or the frequency characteristics of the antenna must be ensured by inspection or adjustment processes, leading to cost increases and decreased productivity.

### BRIEF SUMMARY OF THE INVENTION

Embodiments of the present invention provide an electronic device and an antenna mounting method capable of effectively mounting an antenna inside an electronic device.

According to embodiments of the present invention, there is provided an electronic device including a wireless communication module configured to modulate and demodulate data. The electronic device includes a mounting surface having a predetermined dielectric constant. In one embodiment, the mounting surface is located on a housing of the electronic device. At least one antenna mounting location indicator is provided on the mounting surface. At least one antenna is electrically connected to the wireless communication module and configured to transmit and/or receive a radio signal. The antenna is mounted in contact with the mounting surface in accordance with the antenna mounting location indicator.

At least a portion of the antenna is formed from a substantially planar conductive material and is shaped to have dimensions such that when the antenna is mounted in contact with the mounting surface, a frequency characteristic of the antenna has a value determined in consideration of the predetermined dielectric constant of the mounting surface. According to embodiments of the present invention, the frequency characteristic is the resonant frequency of the antenna and the planar conductive material is a conductive tape that may be mounted to the mounting surface with an adhesive.

According to embodiments of the present invention, the antenna mounting location indicator may be integrally formed with the mounting surface and may comprise a recessed portion of the mounting surface having dimensions adapted to receive the antenna. The recessed portion may have outer dimensions approximately equal to outer dimensions of the antenna and may have a depth less than or equal to a thickness of the antenna.

According to further embodiments of the present invention, the antenna mounting location indicator may comprise at least one projecting portion of the mounting surface. The at least one projecting portion may have outer dimensions approximately equal to outer dimensions of the antenna. In other embodiments, the at least one projecting portion may comprise projecting ribs adapted to receive and surround the antenna when the antenna is mounted on the mounting surface.

According to yet further embodiments of the present invention, the antenna mounting location indicator may comprise a plurality of marks indicating positions of at least two diagonal corners of the at least one antenna.

According to still further embodiments of the present invention, the antenna mounting location indicator may comprise one or more protrusions adapted to mate with one or more corresponding openings formed in the antenna.

According to other embodiments of the present invention, there is provided a method of mounting an antenna for at least one of transmitting and receiving a radio signal in an electronic device having a wireless communication module configured to modulate and demodulate data. At least a portion of the antenna is formed from a substantially planar conductive material such as conductive tape and is shaped to have dimensions such that when the antenna is mounted in contact with the mounting surface, a frequency characteristic of the antenna has a value determined in consideration of the predetermined dielectric constant. The antenna is electrically connected to the wireless communication module and is mounted to the mounting surface in accordance with the at least one antenna mounting location indicator.

Additional features and advantages of the invention will be set forth in the description which follows, and in part will be obvious from the description, or may be learned by practice of the invention.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view of an electronic device in which embodiments of the present invention may be employed;

FIG. 2 is a hardware block diagram of an electronic device in which embodiments of the present invention may be employed;

FIG. 3 is a perspective view of a conductive tape that may be employed to form an antenna, according to embodiments of the present invention;

FIG. 4 is a view illustrating an antenna shape, according to embodiments of the present invention;

FIG. 5 illustrates cutting the antennas out of the conductive tape, according to embodiments of the present invention;

FIG. 6 is a perspective view inside a display case of an electronic device in which embodiments of the present invention may be employed;

FIG. 7 is a sectional view along a line X-X′ of the display case shown in FIG. 6;

FIG. 8 is a sectional view along a line X-X′ of the display case shown in FIG. 6;

FIG. 9 is a perspective view inside a display case illustrating antenna mounting location indicators, according to embodiments of the present invention;

FIG. 10 is a perspective view inside a display case illustrating antenna mounting location indicators, according to embodiments of the present invention;

FIG. 11 is a perspective view inside a display case illustrating antenna mounting location indicators, according to embodiments of the present invention;

FIG. 12 is a perspective view inside a display case illustrating antenna mounting location indicators, according to embodiments of the present invention;

### DETAILED DESCRIPTION OF THE INVENTION

Embodiments of the present invention will be described with reference to the accompanying drawings. A notebook personal computer (PC) is described as a non-limiting example of a device wherein embodiments of the present invention may be employed.

FIG. 1 shows a perspective view of PC 1. This PC 1 is an electronic device capable of performing wireless communication according to the IEEE 802.11b system. IEEE 802.11b is one of the wireless communication standards using the ISM (Industry/Science/Medical) band of a 2.4 GHz band, which uses the Direct Sequence Spread Spectrum (DSSS) as a spread spectrum system and can communicate at a maximum communication rate of 11 Mbps.

The PC 1 has a main case 2, a display case 3, an LCD panel 4, and a keyboard 5. The main case 2 is disposed with the keyboard 5 on the top face part thereof. The main case 2 is pivotally joined to the display case 3 with hinge parts 6. The display case 3 supports the periphery of the LCD panel 4 so as to view the display area of the LCD panel 4. The display case 3 is configured as an upper case disposed with the LCD 4 and a under case as a backside of the LCD. The display case 3 is pivotally moved in the direction of an arrow A-B through the hinge parts 6 between a closed position covering the keyboard 5 and an opened position allowing use of the keyboard 5.

Antennas 7 and 8 for performing wireless communication are mounted inside the display case 3. Because radio antennas are ideally disposed in upper positions for better receiving sensitivity, the antennas 7 and 8 are disposed in the upper part of the display case 3 such that they are raised to a higher position when display case 3 is opened for using PC 1.

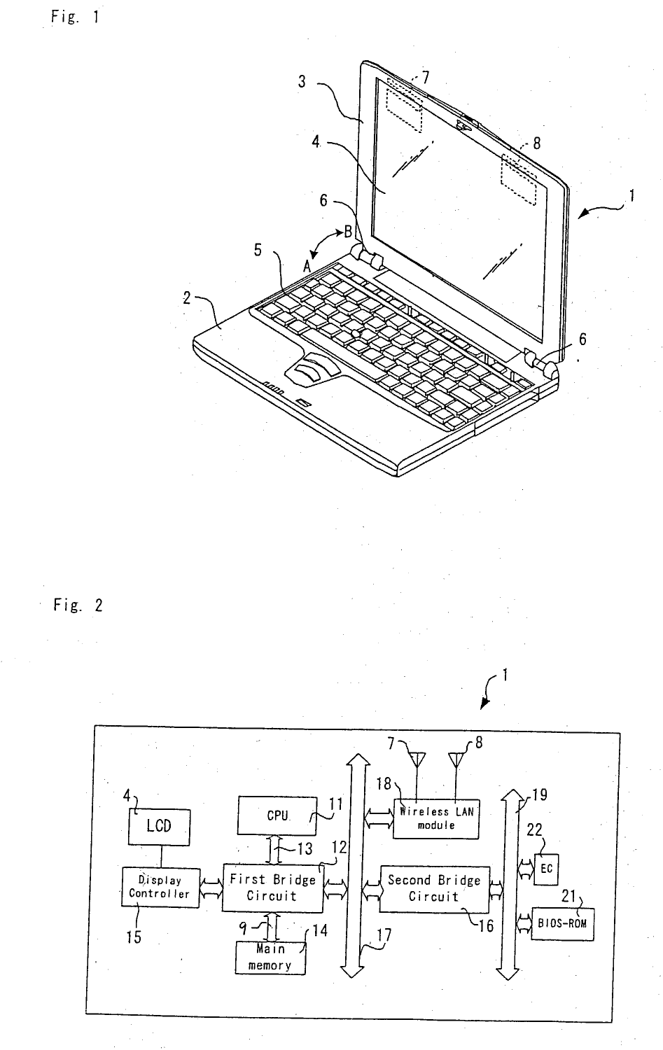

FIG. 2 is a hardware block diagram of the PC of the first embodiment. Inside the main body of the PC 1, a CPU 11 is connected to a first bridge circuit 12 with a CPU local bus 13 having a data bus of a 64-bit width, and the first bridge circuit 12 is connected to a main memory 14 through a memory bus 9. Additionally, the first bridge circuit 12 is connected to a display controller 15 that controls the display of the LCD 4. The first bridge circuit 12 is connected to a second bridge circuit 16 with a high-speed bus 17 having a 32-bit wide data bus. The high-speed bus 17 is connected to a wireless LAN module 18 for processing modulation and demodulation of radio signals based on the IEEE 802.11b system. The second bridge circuit 16 is connected to a low-speed bus 19, and the low-speed bus 19 is connected to a BIOS-ROM 21 and an embedded controller 22 (hereinafter referred to as EC 22).

The CPU 11 executes operational control, data processing, and the like for PC 1. The main memory 14 is a memory device that stores an operating system, device drivers, application programs to be executed, processing data, and comprises a plurality of DRAMs and the like.

The first bridge circuit 12 is a bridge LSI coupling the CPU local bus 13 and the high-speed bus 17, which functions as a bus master device for the high-speed bus 17. This first bridge circuit 12 has functions of converting bus width including data and addresses between the CPU local bus 13 and the high-speed bus 17 and of performing access control for the main memory 14 through the memory bus 9.

The high-speed bus 17 is a clock synchronous input/output bus, and cycles on the high-speed bus 17 are performed in synchronism with high-speed bus clocks. This high-speed bus 17 has an address/data bus for use in time division.

The high-speed bus 17 is connected to the wireless LAN module 18. This wireless LAN module 18 processes signal modulation and demodulation of wireless data based on IEEE 802.11b, which responds to a diversity receiving system. Furthermore, the wireless LAN module 18 is connected through coaxial cables to the antennas 7 and 8 that are interfaces for wireless signal transmission and reception.

In the diversity system, one antenna (main antenna) is used for both transmission and reception, while the other antenna (sub antenna) is used only for data reception. Generally, the main antenna is used for data transmission, and one of the main antenna or sub antenna is used for data reception, depending on which of the two has a higher level of signal reception. In this manner, level variations in received radio waves are reduced as much as possible.

The second bridge circuit 16 is a bridge LSI coupling the high-speed bus 17 and the low-speed bus 19 and performs bus conversion or the like between the high-speed bus 17 and the low-speed bus 19. The BIOS-ROM 21 is a program that is read out upon startup of PC 1 that systematizes function-executing routines for accessing a variety of hardware inside PC 1. Generally, the BIOS is stored in a non-volatile memory (for example flash ROM) inside PC 1.

The EC 22 includes a plurality of register groups readable/writable by the CPU 11. Using these register groups allows communications between the CPU 11 and devices connected to the EC 22. Additionally, EC 22 also functions as a keyboard controller.

According to the system configuration described above, wireless communication based on IEEE 802.11b may be performed by PC 1 with other wireless communication devices outside of PC 1.

An antenna and antenna mounting method according to embodiments of the present invention will now be described. FIG. 3 is a perspective view of a conductive tape 31 that may be used as a substantially planar conductive material for the antenna, according to an embodiment of the present invention.

This conductive tape 31 includes a conductive member such as a copper or aluminum foil, one surface of which includes an adhesive material. The adhesive surface of the conductive tape 31 is covered by a removable paper. The conductive tape 31 can be affixed or mounted on an object by removing the paper to expose the adhesive surface and applying the adhesive surface to a surface of the object. The conductive tape 31 is very flexible and is easily mounted on the PC housing. This conductive tape 31 may be die-cut or otherwise formed into a shape for use as an antenna.

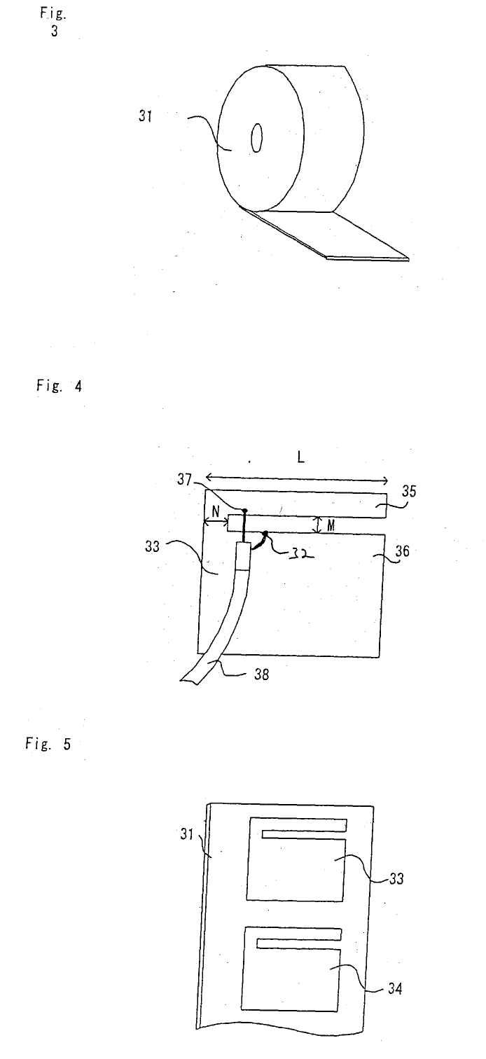

FIG. 4 illustrates one such antenna shape that may be formed using conductive tape 31. As shown in FIG. 4, conductive tape 31 may be formed into a reverse F-shaped antenna 33 having substantially planar sides. Antenna 33 includes a radio wave emitting element 35 on an upper portion and a ground (GND) 36 on a lower portion. The element 35 includes a feed point 37; the position of which is determined so as to have the same impedance (50 Ω, for example) as a coaxial cable 38 to be connected thereto. GND 36 includes a point 32 for connecting the shield of the coaxial cable 38.

In one embodiment, the outer dimensions (i.e., the dimensions of the outer periphery) of the antenna 33, are approximately 30×30 mm when radio waves in a 2.4 GHz band are used. The dimensions of antenna 33 may be varied to change particular antenna characteristics. For example, the resonant frequency of antenna 33 may be varied in accordance with the length of element 35 (dimension L). Thus, as element 35 becomes shorter; the resonant frequency of antenna 33 becomes higher. The dimension L may be set to a quarter wavelength of the resonant frequency. Similarly, a frequency band of antenna 33 may be varied in accordance with dimensions M and N. Therefore, by choosing suitable values for dimensions such as L, M and N, a designer may form an appropriate antenna from the conductive tape 31 for a particular application.

As discussed above, when antenna 33 is mounted in contact with a PC housing, the dielectric constant of the PC housing may change the frequency characteristics of the antenna. Thus, when antenna 33 is affixed to a surface of PC 1, the resonant frequency of the antenna 33 may be changed by an amount dependant on the dielectric constant of the surface material. Because of this, the dimensions of the antenna 33 are chosen such that when in contact with the surface of PC 1 (i.e., when the antenna 33 is mounted on the PC 1), the correct characteristics for the antenna 33 are achieved. When these dimensions are determined for PC 1, antennas 33 and 34 (to be used, for example, as a diversity antenna pair) are easily die-cut out of the conductive tape 31, as shown in FIG. 5. Thus, this method of forming antennas is also conducive to the mass-production of antennas to be used with particular wireless devices.

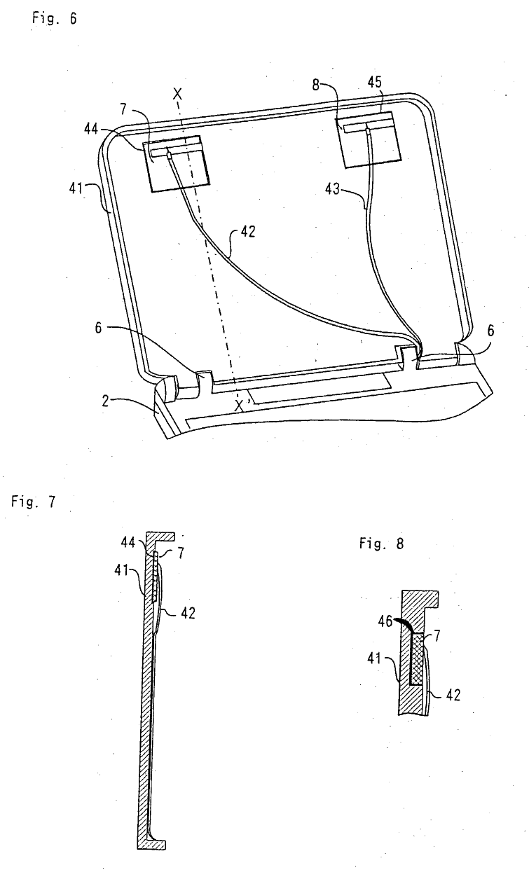

FIG. 6 is a perspective view illustrating the inside of the display case 3 of PC 1 with the upper case removed. A pair of antennas 7, 8 similar to antenna 33 are mounted to under case 41 of display case 3. Die-cut antennas 7 and 8 are mounted in recessed portions 44 and 45 in under case 41 such that substantially all of a planar side of each of antennas 7 and 8 contacts the mounting surface. Recessed portions 44 and 45 function as antenna mounting location indicators that may be used during the assembly process to accurately place the antennas on PC 1. They may be integrally formed in the under case 41 during, for example, a molding process, and are formed to have a size corresponding to that of the antennas 7 and 8. In other words, they are formed to have approximately the same outer dimensions as antennas 7 and 8.

Coaxial cables 42 and 43 are connected, for example with solder, to feed points of antenna 7 and antenna 8, respectively. The other ends of coaxial cables 42 and 43 are connected to the wireless module 18 disposed inside the main case 2 through the hinge part 6.

FIG. 7 illustrates a sectional view of PC 1 taken along the line X-X′ shown in FIG. 6. As shown in FIG. 7, the antenna 7 is mounted on the recessed portion 44 in the under case 41. According to the embodiment shown in FIG. 7, the depth of recessed portion 44 is less than the thickness of the antenna 7, such that a part of antenna 7 protrudes above the surface of under case 41.

FIG. 8 illustrates a sectional view of a PC having an antenna 7 positioned in under case 41, according to another embodiment of the present invention. As shown in FIG. 8, the antenna 7 is mounted on a recessed portion 46. The depth of the recessed portion 46 is chosen such that it is approximately equal to the thickness of antenna 7, whereby the antenna 7 may be mounted flush with the surface of under case 41. The embodiment shown in FIG. 8 is advantageous in that less space is required above the surface of under case 41 for mounting antenna 7.

Thus, according to embodiments of the present invention described above, a material having a conductive member (such as conductive tape having an aluminum or copper foil) may be formed into an antenna, the dimensions of which are chosen in consideration of the changes in characteristics of the antenna that will be brought about by mounting the antenna on a particular mounting surface. Accordingly, separation of the antenna from the particular mounting surface (for example, by a spacer) is not required and the antenna mounting space can thereby be reduced.

Furthermore, according to embodiments of the present invention, antenna mounting location indicators are included on the mounting surface of the electronic device to facilitate accurate placement of the antennas. Thus, uniformity of antenna placement on the electronic device during the assembly process results in uniformity of antenna characteristics for a large number of wireless devices.

In one embodiment, the dimensions of the antenna are chosen in consideration of the predetermined dielectric constant of a particular mounting surface such that desirable frequency characteristics of the antenna are achieved when the antenna is in contact with the particular mounting surface. The antenna with the desired dimensions may be formed (for example by cutting) and is mounted with an adhesive material in accordance with antenna mounting location indicators on the electronic device. The antenna mounting location indicators may be recessed portions formed in the mounting surface of the device.

In the embodiments of the present invention described above, the 802.11b system for wireless communications was described. However, embodiments of the present invention may be employed in other wireless communication systems such as, but not limited to, Bluetooth or 802.11a.

Furthermore, although in the embodiments of the present invention described above the conductive member included a conductive tape having an aluminum or copper foil thereon and an adhesive surface, other conductive materials and application methods may also be possible.

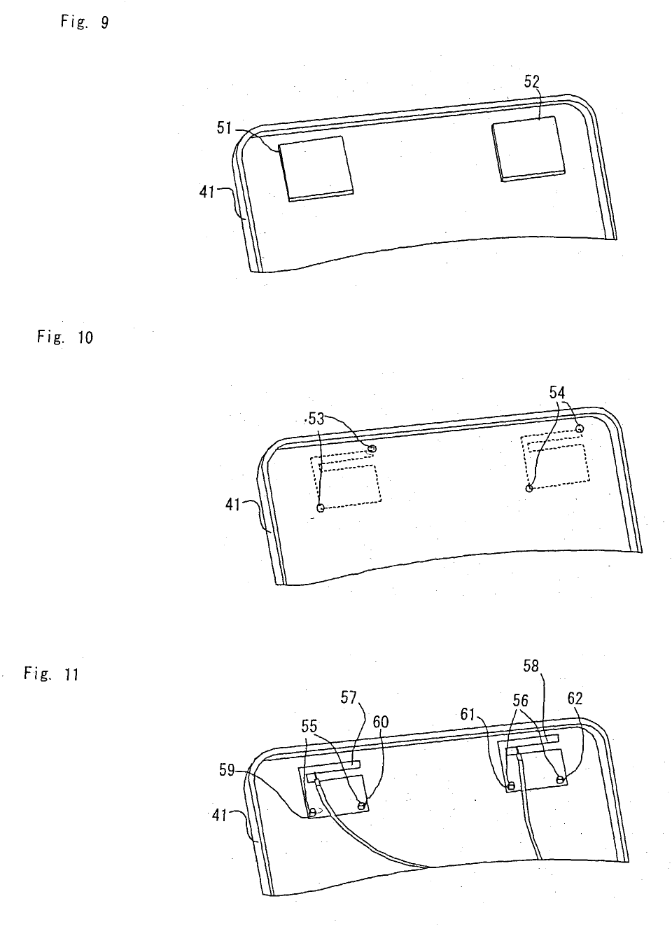

Further embodiments of the present invention will now be described with reference to FIGS. 9, 10, 11 and 12. FIGS. 9 to 12 depict perspective views illustrating the inside of the display case 3 of PC 1.

FIG. 9 shows projecting portions 51 and 52 on the under case 41 of PC 1. Projecting portions 51 and 52 function as antenna mounting location indicators and may be integrally formed in the under case 41 during, for example, a molding process. Thus, projecting portions 51 and 52 will have the same dielectric constant as the surface of under case 41. Projecting portions 51 and 52 are formed to have a size corresponding to antennas to be placed thereon (not shown). In other words, they are formed to have approximately the same outer dimensions as the antennas.

In one embodiment, antennas similar to antennas 7 and 8 (FIG. 6) may be mounted on projecting portions 51 and 52, respectively. The dimensions of the antennas are chosen such that desirable frequency characteristics of the antennas are achieved when the antennas are mounted to projecting portions 51 and 52. As in previously described embodiments, the antennas with the desired dimensions may be formed out of a material with a conductive member (such as conductive tape having an aluminum or copper foil). They may then be mounted to the projecting portions 51 and 52, for example with an adhesive.

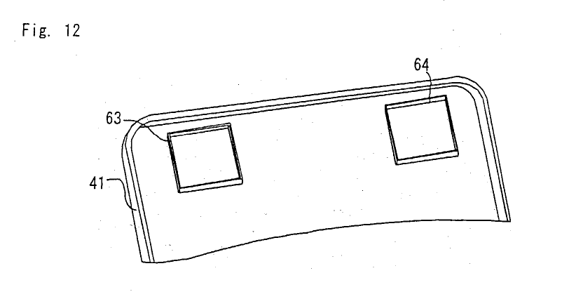

A further embodiment of the present invention is shown in FIG. 10. As shown in FIG. 10, marks 53 (two) and 54 (two) are provided on the under case 41 at positions indicating diagonal corners of the mounted antenna. Marks 53 and 54 function as antenna mounting location indicators and may be integrally formed in the under case 41 during, for example, a molding process. Marks 53 and 54 allow for accurate placement of the antennas onto the surface of the under case 41 during an assembly process. In this manner, there is uniformity in antenna placement and a corresponding uniformity in the antenna characteristics is achieved for a large number of wireless devices.

Yet a further embodiment of the present invention is shown in FIG. 11. As shown in FIG. 11, the under case 41 includes protrusions 55 (two) and 56 (two). Protrusions 55 and 56 function as antenna mounting location indicators and may be integrally formed in the under case 41 during, for example, a molding process. Antennas 57 and 58 include corresponding openings 59, 60 and 61, 62, respectively. Openings 59, 60 and 61, 62 may be cut, punched or otherwise formed in the antenna during the antenna forming process.

During the assembly process, openings 59, 60 of antenna 57 mate with protrusions 55. Similarly, openings 61, 62 of antenna 58 mate with protrusions 56. In this manner, antennas 57 and 58 may be accurately mounted onto the surface of the under case 41 during the assembly process. Thus, uniformity in antenna placement leads to a corresponding uniformity in the antenna characteristics for a large number of wireless devices, for example PCs.

Another embodiment of the present invention is shown in FIG. 12. As shown in FIG. 12, the under case 41 includes projecting ribs 63 and 64. Projecting ribs 63 and 64 function as antenna mounting location indicators and may be integrally formed in the under case 41 during, for example, a molding process. The dimensions of projecting ribs 63 and 64 are chosen such that antennas similar to antennas 7 and 8 (FIG. 6) may be affixed onto the surface of under case 41 in the areas enclosed by the projecting ribs 63 and 64. In this manner, the antennas may be accurately mounted onto the surface of the under case 41 during the assembly process. Thus, uniformity in antenna placement leads to a corresponding uniformity in the antenna characteristics for a large number of wireless devices.

As illustrated by embodiments of the present invention described above, antennas for an electronic device may be formed from conductive tape after consideration of the changes in characteristics of the antennas that will be brought about by mounting the antennas on a surface of the device, for example on the housing of the device. The conductive tape may include an adhesive material for affixing the antenna to the surface of the device. Because no spacer is required for mounting the antenna, there is a resultant saving of space. Furthermore, the electronic device may include various types of antenna mounting location indicators to facilitate accurate and uniform placement of the antennas, thus ensuring uniformity in the antenna characteristics for a large number of wireless devices. In this manner, costs are reduced and productivity is enhanced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic device comprising:
a mounting surface having a predetermined dielectric constant;
at least one antenna mounting location indicator located on the mounting surface;
a wireless communication module configured to modulate and demodulate data; and
at least one antenna electrically connected to the wireless communication module and configured to perform at least one of transmitting and receiving a radio signal, the at least one antenna being mounted in contact with the mounting surface in accordance with the at least one antenna mounting location indicator;
wherein at least a portion of the at least one antenna is formed from a substantially planar conductive material and is shaped to have dimensions such that when the at least one antenna is mounted in contact with the mounting surface, a frequency characteristic of the at least one antenna has a value determined in consideration of the predetermined dielectric constant.

2. The electronic device according to claim 1, wherein the substantially planar conductive material is a conductive tape.

3. The electronic device according to claim 1, wherein the frequency characteristic is a resonant frequency of the at least one antenna.

4. The electronic device according to claim 1, wherein the at least one antenna is a reverse F-shaped antenna.

5. The electronic device according to claim 1, wherein the at least one antenna includes a substantially planar side, substantially all of which contacts the mounting surface.

6. The electronic device according to claim 1, wherein the at least one antenna is mounted in contact with the mounting surface using an adhesive material.

7. The electronic device according to claim 1, wherein the at least one antenna mounting location indicator is integrally formed with the mounting surface.

8. The electronic device according to claim 1, wherein the at least one antenna mounting location indicator comprises a recessed portion of the mounting surface having dimensions adapted to receive the at least one antenna.

9. The electronic device according to claim 8, wherein the recessed portion has outer dimensions approximately equal to outer dimensions of the at least one antenna.

10. The electronic device according to claim 8, wherein the recessed portion has a depth less than a thickness of the at least one antenna.

11. The electronic device according to claim 8, wherein the recessed portion has a depth approximately equal to a thickness of the at least one antenna.

12. The electronic device according to claim 1, wherein the at least one antenna mounting location indicator comprises at least one projecting portion of the mounting surface.

13. The electronic device according to claim 12, wherein the at least one projecting portion has outer dimensions approximately equal to outer dimensions of the at least one antenna.

14. The electronic device according to claim 12, wherein the at least one projecting portion comprises projecting ribs adapted to receive and surround the at least one antenna when the at least one antenna is mounted on the mounting surface.

15. The electronic device according to claim 1, wherein the at least one antenna mounting location indicator comprises a plurality of marks indicating positions of at least two diagonal corners of the at least one antenna.

16. The electronic device according to claim 1, wherein the at least one antenna mounting location indicator comprises at least one protrusion adapted to mate with at least one corresponding opening in the at least one antenna.

17. The electronic device according to claim 1, wherein the mounting surface is located on a housing of the electronic device.

18. The electronic device according to claim 1, further including a rotatable display and having the mounting surface located in an upper portion of the rotatable display.

19. A method of mounting an antenna in an electronic device for at least one of transmitting and receiving a radio signal, the method comprising:
selecting a mounting surface for mounting the antenna, the mounting surface having a predetermined dielectric constant;
providing at least one antenna mounting location indicator on the mounting surface;
providing a wireless communication module configured to modulate and demodulate data;
providing at least one antenna, at least a portion of which is formed from a substantially planar conductive material and is shaped to have dimensions such that when the at least one antenna is mounted in contact with the mounting surface, a frequency characteristic of the at least one antenna has a value determined in consideration of the predetermined dielectric constant;
electrically connecting the at least one antenna to the wireless communication module; and
mounting the antenna to the mounting surface in accordance with the at least one antenna mounting location indicator.

20. The method according to claim 19, wherein the substantially planar conductive material is a conductive tape.

21. The method according to claim 19, wherein the at least one antenna is a reverse F-shaped antenna.

22. The method according to claim 19, wherein the at least one antenna includes a substantially planar side, substantially all of which contacts the mounting surface.

23. The method according to claim 19, wherein the frequency characteristic is a resonant frequency of the at least one antenna.

24. The method according to claim 19, wherein the at least one antenna mounting location indicator is integrally formed with the mounting surface.

25. The method according to claim 19, wherein the at least one antenna mounting location indicator comprises a recessed portion of the mounting surface having dimensions adapted to receive the at least one antenna.

26. The method according to claim 19, wherein the at least one antenna mounting location indicator comprises at least one projecting portion of the mounting surface.

27. The method according to claim 26, wherein the at least one projecting portion has outer dimensions approximately equal to outer dimensions of the at least one antenna.

28. The method according to claim 26, wherein the at least one projecting portion comprises projecting ribs adapted to receive and surround the at least one antenna when the at least one antenna is mounted on the mounting surface.

29. The method according to claim 19, wherein the at least one antenna mounting location indicator comprises a plurality of marks indicating positions of at least two diagonal corners of the at least one antenna.

30. The method according to claim 19, wherein the at least one antenna mounting location indicator comprises at least one protrusion adapted to mate with at least one corresponding opening in the at least one antenna.
